(19) United States
(12) Patent Application Publication
(10) Pub. No.: US 2013/0206750 A1
(43) Pub. Date: Aug. 15, 2013

(54) HEATING APPARATUS

(71) Applicants: Daniel Anton Falcon, Zaragoza (ES); Josê Miguel Burdio Pinilla, Zaragoza (ES); Claudio Carretero Chamarro, Zaragoza (ES); Jose Maria De la Cuerda Ortin, Zaragoza (ES); Pablo Jesus Hernandez Blasco, Cuarte de Huerva (Zaragoza) (ES); Oscar Jimenez Navascues, Cintruenigo (ES); Sergio Llorente Gil, Zaragoza (ES); Denis Navarro Tabernero, Zuera (Zaragoza) (ES); Jose Joaquin Paricio Azcona, Zaragoza (ES); Diego Puyal Puente, Zaragoza (ES); Magdy Saoudi Abdelfatah Saoudi, Hefna-Belbeis-Elsharkia (EG)

(72) Inventors: Daniel Anton Falcon, Zaragoza (ES); Josê Miguel Burdio Pinilla, Zaragoza (ES); Claudio Carretero Chamarro, Zaragoza (ES); Jose Maria De la Cuerda Ortin, Zaragoza (ES); Pablo Jesus Hernandez Blasco, Cuarte de Huerva (Zaragoza) (ES); Oscar Jimenez Navascues, Cintruenigo (ES); Sergio Llorente Gil, Zaragoza (ES); Denis Navarro Tabernero, Zuera (Zaragoza) (ES); Jose Joaquin Paricio Azcona, Zaragoza (ES); Diego Puyal Puente, Zaragoza (ES); Magdy Saoudi Abdelfatah Saoudi, Hefna-Belbeis-Elsharkia (EG)

(73) Assignee: BSH BOSCH UND SIEMENS HAUSGERÄTE GMBH, Munich (DE)

(21) Appl. No.: 13/882,754

(22) PCT Filed: Oct. 31, 2011
(86) PCT No.: PCT/IB11/54819

§ 371 Date: May 1, 2013

(30) Foreign Application Priority Data
Nov. 10, 2010 (ES) P201031651

(51) Int. Cl. H05B 1/02; H05B 6/06; H05B 6/12

(52) U.S. Cl. CPC H05B 1/0266; H05B 6/1209; H05B 6/062
USPC 219/622; 219/481; 219/452.12; 219/663

(57) ABSTRACT

A heating apparatus, in particular a hob heating apparatus, with at least one heating connection for at least one heating element and at least one frequency unit. In order to provide a heating apparatus of the generic type with relatively high operational reliability, it is proposed that the heating apparatus comprises a protective unit, which is provided for determining the existence of a conducting path between the frequency unit and the at least one heating connection.

The invention is based on a heating apparatus according to the preamble of claim 1.

Heating apparatuses for cooktops are known, which comprise quite a large number of heating elements as frequency units. The heating elements are assigned to the frequency units by way of a switching arrangement of the heating apparatus.

The object of the invention is in particular to provide a generic heating apparatus with greater operational reliability. According to the invention the object is achieved by the features of claim 1 and the method claim 9, while advantageous embodiments and developments of the invention will emerge from the subclaims.

The invention is based on a heating apparatus, in particular a cooktop heating apparatus, having at least one heating connection for at least one heating element and having at least one frequency unit.

It is proposed that the heating apparatus has a protective unit, which is provided to determine the existence of a conducting path between the frequency unit and the heating connection. “Provided” here means in particular specially designed and/or equipped and/or programmed. A “heating element” refers in particular to an element which is provided to convert electrical energy to heat. In particular the heating element consists of a resistance heating unit or a radiant heating unit or preferably an induction heating unit, which is provided to convert electrical energy to heat indirectly by way of induced eddy currents. A “frequency unit” refers in particular to an electrical unit, which supplies the heating element with electrical energy. The frequency unit is preferably provided to generate an oscillating electrical signal, preferably with a frequency of at least 1 kHz, in particular at least 10 kHz and advantageously at least 20 kHz. The frequency unit preferably comprises at least one inverter, which particularly advantageously has two switching units. A “switching unit” refers in particular to a unit, which is provided to interrupt a conducting path containing the switching unit. The switching unit is preferably a bidirectional unipolar switch, which in particular allows a current flow through the switch along the conducting path in both directions and which in particular short circuits an electrical voltage in at least one poling direction. The inverter preferably comprises at least two bipolar transistors with isolated gate electrodes and in particular at least one damping capacitor. A “conducting path” refers in particular to a path between two points that is electrically conducting in particular for direct current. A specific electrical resistance everywhere on the conducting path at 20° C. is preferably maximum 10⁻⁴ Ωm, in particular maximum 10⁻⁵ Ωm, advantageously maximum 10⁻⁶ Ωm and particularly advantageously maximum 10⁻⁷ Ωm. The conducting path is preferably free of heating elements. The conducting path preferably comprises at least one further component that is not a conductor piece or a heating element, preferably a switching element of a switching arrangement and particularly advantageously a relay. A “heating connection” of a heating element refers in particular to an electrical connection point of the heating element. The electrical connection point is preferably a connecting point between a power supply line of the heating element, in particular a power supply cable of the heating element, and a further power supply line, in particular a conductor path of a printed circuit board. The heating connection is preferably provided on a face facing away from the frequency unit when viewed in the direction of the conducting path between the frequency unit and the heating connection, to connect the heating element electrically. A “protective unit” refers in particular to a unit, in particular an electronic unit, which has a protection function. The protection function preferably includes identifying a conducting path and forwarding this information to a control unit.

Such an embodiment allows operational reliability to be improved, in particular when the heating apparatus has a switching arrangement with switching elements, preferably in the form of electromechanical relays, and these are provided for periodic switching in the context of a time multiplex method. A “time multiplex method” refers in particular to a control method, with which individual time segments are defined, which are preferably run through periodically one after the other in a recurrent manner. In particular during a transition from a first to a second time segment a switching state of the switching arrangement changes, preferably so that in the first time segment at least a first heating element is supplied with energy and in the second time segment at least a second heating element is supplied with energy. In particular a power supplied to the heating elements during a time segment is greater than an average power supplied to the heating elements over time. A period duration of the control method is preferably 1 s to 5 s. The protective unit allows operating safety to be increased, as it is possible to identify the erroneous existence of a conducting path. In particular with a cooktop this prevents heating elements being operated load-free or with an empty cookpot. With induction cooktops in particular it is also possible to prevent magnetic fields spreading freely from the heating elements in the environment of the induction cooktop.

It is further proposed that the protective unit is provided to determine the existence of the conducting path based on a potential profile. A “potential profile” refers in particular to a time profile of an electrical potential, preferably at one point on the conducting path. An “electrical potential” at one point refers in particular to a path integral over an electric field from a reference point to the point. The reference point for the electrical potential is preferably a point on a ground line of the frequency unit. This reduces costs considerably, as there is no need for expensive current measuring devices for high-frequency alternating currents.

The protective unit is advantageously provided to analyze the potential profile at the heating connection. The statement that the protective unit is provided “to analyze the potential profile at the heating connection” means in particular that the protective unit is supplied with and internally processes an electrical voltage between the heating connection or a point with essentially the same electrical potential as the heating connection and the reference point as input voltage. “Essentially the same electrical potential” refers in particular to an electrical potential with a deviation of maximum 1% and preferably maximum 0.1%. An output voltage of the protective unit is preferably a digital output signal, which can in particular only have two values. This allows the existence of the conducting path to be determined reliably.

In one preferred embodiment it is proposed that the protective unit is provided to determine the existence of the conducting path based on a frequency spectrum of the potential profile. A “frequency spectrum” of the potential profile refers in particular to a mathematical function that is a function of a frequency, which describes the composition of the potential profile from signal components of different frequency. The statement that the protective unit is provided “to determine the existence of the conducting path based on a frequency spectrum of the potential profile” means in particular that the output signal and preferably the output voltage of the protective unit is a function of the frequency spectrum. In particular the protective unit identifies from the presence of high-frequency signals of a certain intensity in the frequency spectrum, in particular above a limit frequency, that a conducting path exists between the frequency unit and the heating connection. This allows the existence of the conducting path to be determined particularly reliably.

The protective unit advantageously comprises at least one high-pass filter, which is provided to discriminate between potential profiles. A “high-pass filter” refers in particular to an electronic filter unit, which is provided to allow the passage of signals with a frequency above a limit frequency at least essentially unattenuated and to damp signals with a lower frequency. “At least essentially unattenuated” means in particular that signal attenuation is maximum 15%, in particular maximum 10%, advantageously maximum 5% and particularly advantageously maximum 1%. The high-pass filter preferably comprises at least one capacitor. This allows discrimination between potential profiles in a simple and economical manner.

In a further embodiment of the invention it is proposed that the protective unit comprises a current sensor, which is provided to determine the existence of the conducting path. A “current sensor” refers in particular to a unit, which is provided to detect at least the presence of an electrical current. This saves costs compared with an embodiment with a current measuring device designed to measure a high-frequency alternating current.

It is further proposed that the heating apparatus comprises a control unit, which is provided to receive connection information from the protective unit and to initiate at least one safety measure in the event of the erroneous existence of a conducting path. A “control unit” refers in particular to an electronic unit, which is preferably at least partially integrated in a control and/or regulation unit of an induction cooktop and is preferably provided to control and/or regulate at least the frequency unit and a switching arrangement. The control unit preferably comprises a computation unit and in addition to the computation unit a storage unit. “Connection information” refers in particular to a connection status between the frequency unit and the heating connection. The connection information is preferably encoded in a digital signal, which can preferably only have two values. The “erroneous existence of the conducting path” refers in particular to an existence of the conducting path between the frequency unit and the heating connection, which is erroneous and deviates from a setting of the switching arrangement set by the control unit. In particular an erroneous existence of a conducting path can be due to a defective switching element, in particular a catching electromechanical relay and/or erroneous activation of the switching element. A “safety measure” refers in particular to a measure which is initiated in response to the erroneous existence of the conducting path and which is preferably intended to render the heating apparatus safe. The safety measure preferably comprises switching off all the frequency units. The safety measure preferably comprises outputting an error message and/or a maintenance request. Such an embodiment improves operating safety particularly advantageously.

A total number of all heating elements is advantageously greater than a total number of all frequency units. A “total number of all heating elements” refers in particular to the total number of all the heating elements in a cooktop. A “total number of all frequency units” refers in particular to the total number of all the frequency units in the cooktop. This reduces materials and costs. The total number of frequency units is advantageously two in the case of a cooktop having at least three heating elements. The total number of frequency units is advantageously four in the case of a matrix cooktop. A “matrix cooktop” refers in particular to a cooktop, in which the heating elements are arranged in a regular grid below a cooktop plate and a region of the cooktop plate that can be heated by means of the heating elements comprises preferably at least 60%, in particular at least 70%, advantageously at least 80% and particularly advantageously at least 90% of the overall surface of the cooktop plate. In particular the matrix cooktop comprises at least 10, in particular at least 20, advantageously at least 30 and particularly advantageously at least 40 heating elements. This ensures a high level of ease of operation despite a limited number of frequency units, in particular in the case of matrix cooktops, with which experience shows that generally a maximum of four cookpots are heated.

A method with an inventive heating apparatus, in particular a cooktop apparatus, having at least one heating connection for at least one heating element, at least one frequency unit and a protective unit, is also proposed, with which the protective unit determines the existence of a conducting path between the frequency unit and the heating connection. This improves operational reliability, in particular when the heating apparatus has switching elements, preferably in the form of electromechanical relays. Operating safety can also be improved, as the erroneous existence of a conducting path can be identified. This prevents heating elements being operated load-free, in particular in the case of a cooktop. It is also possible, in particular in the case of induction cooktops, to prevent magnetic fields spreading freely from the heating elements in the environment of the induction cooktop.

Further advantages will emerge from the descriptions of the drawings which follow. The drawings show two exemplary embodiments of the invention. The drawings, description and claims contain numerous features in combination. The person skilled in the art will expediently also consider the features individually and combine them in expedient further combinations.

In the drawings:

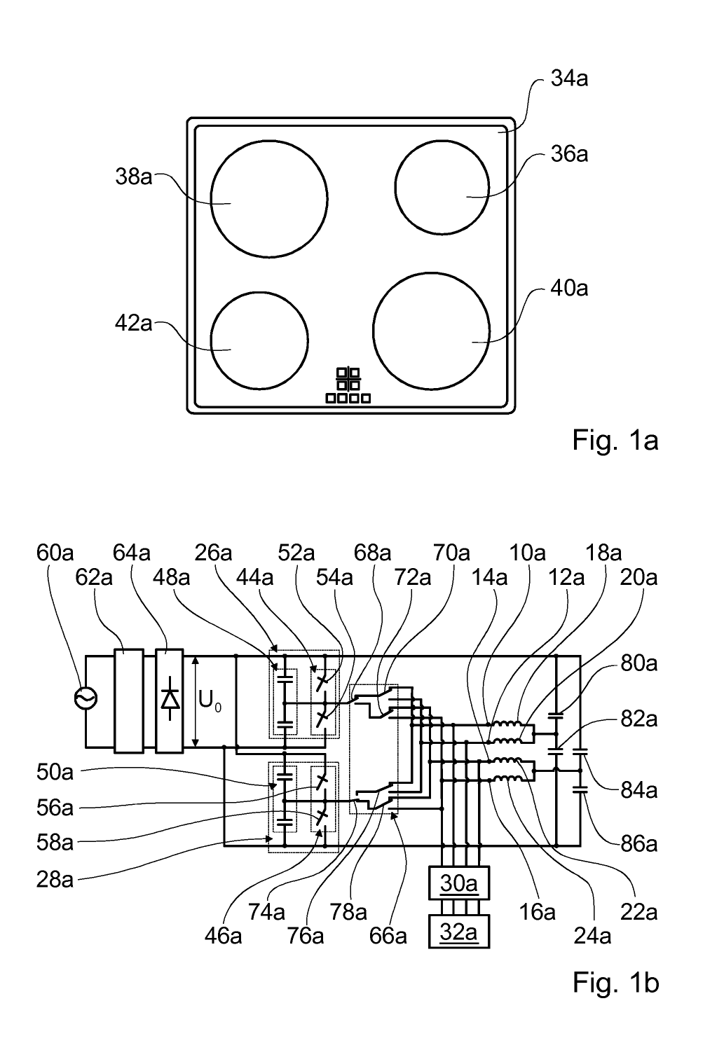

FIG. 1a shows an induction cooktop with four heating zones viewed from above,

FIG. 1b shows a heating apparatus of the induction cooktop from FIG. 1a,

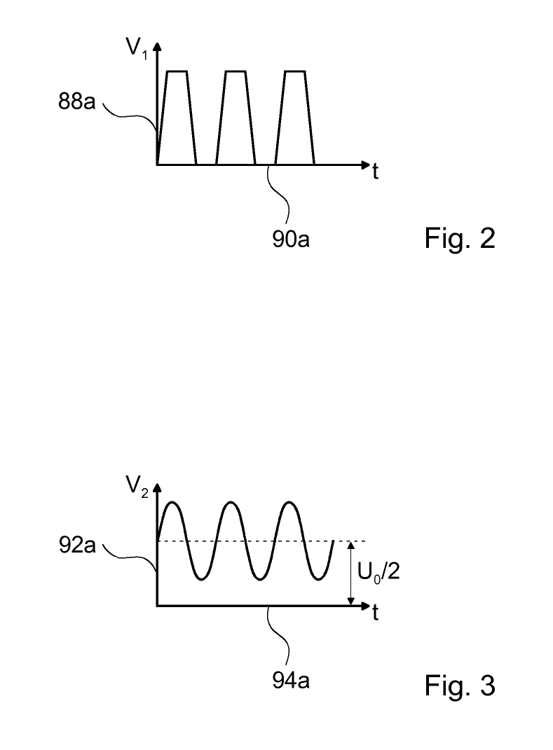

FIG. 2 shows a potential profile for an existing connection,

FIG. 3 shows a potential profile for an isolated connection,

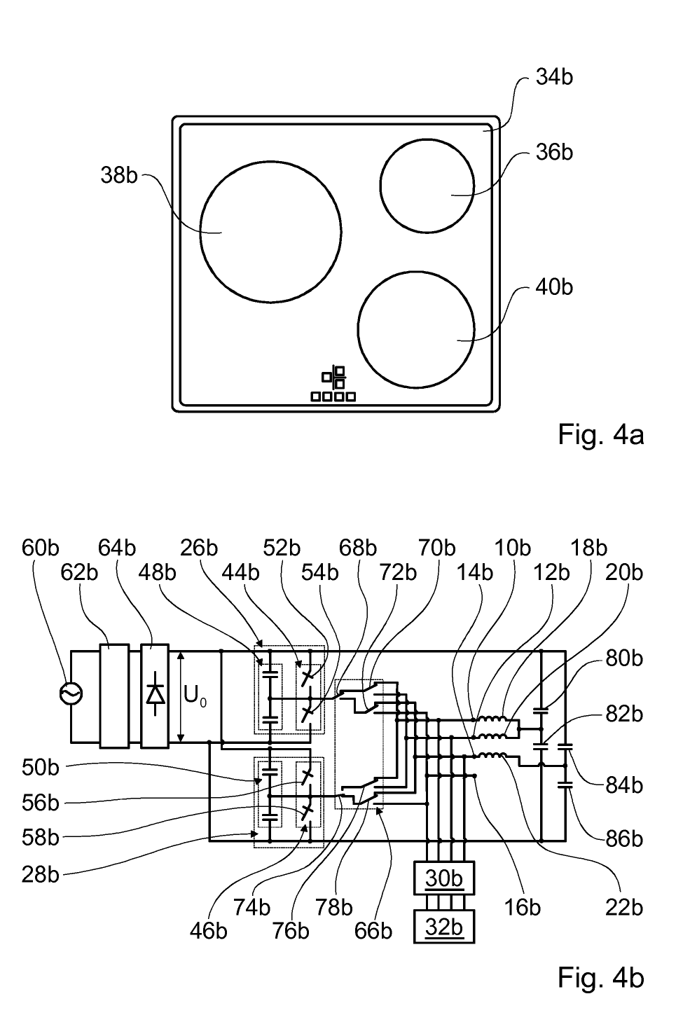

FIG. 4a shows an induction cooktop with three heating zones viewed from above, and

FIG. 4b shows a heating apparatus of the induction cooktop from FIG. 4a.

FIG. 1a shows a top view of an induction cooktop with a cooktop plate 34a made of glass ceramic, on which four heating zones 36a, 38a, 40a, 42a are marked in the known manner. A heating apparatus (FIG. 1b) of the induction cooktop has four heating elements 18a, 20a, 22a, 24a configured as inductor coils, which can all be operated at the same time at different power stages. Each of the heating elements 18a, 20a, 22a, 24a is assigned to one of the cooking zones 36a, 38a, 40a, 42a, so that when the induction cooktop is used, each heating element 18a, 20a, 22a, 24a heats just one cookware element, for example a pot or pan. The heating apparatus has two frequency units 26a, 28a, by means of which the heating elements 18a, 20a, 22a, 24a can be supplied with energy by way of heating connections 10a, 12a, 14a, 16a of the heating apparatus. A total number of all heating elements 18a, 20a, 22a, 24a is therefore greater than a total number of all frequency units 26a, 28a. The two frequency units 26a, 28a each comprise an inverter 44a, 46a and a damping capacitor unit 48a, 50a. The inverter 44a has a first bipolar transistor with isolated gate electrode (the abbreviation IGBT is used in the following for this) 52a and a second IGBT 54a. The inverter 46a also has a first IGBT 56a and a second IGBT 58a. Alternatively instead of the IGBTs any other switching unit that appears expedient to the person skilled in the art can be used, preferably however a bidirectional unipolar switch.

The heating apparatus also has a country-specific alternating current voltage source 60a, which supplies a power network voltage with an effective value of 230 V and a frequency of 50 Hz. The described heating apparatus is intended in particular for operation in Germany. For heating apparatuses which are intended for operation in the US a corresponding alternating current voltage source supplies a power network voltage with 60 Hz. The voltage of the alternating current voltage source 60a passes first through a filter 62a of the heating apparatus, which eliminates high-frequency noise and is essentially a low-pass filter. A voltage filtered by the filter 62a is rectified by a rectifier 64a of the heating apparatus, which can be configured as a bridge rectifier, so that a rectified voltage U₀ is output at an output of the rectifier 64a and is present between a collector of the IGBT 52a and an emitter of the IGBT 54a. The rectified voltage U₀ is also present between a collector of the IGBT 56a and an emitter of the IGBT 58a. The damping capacitor units 48a, 50a each consist of two capacitors, with a first capacitor connected parallel to the first IGBT 52a, 56a and a second capacitor connected parallel to the second IGBT 54a, 58a of the respective frequency unit 26a, 28a.

The heating apparatus also has a switching arrangement 66a. The switching arrangement 66a comprises six switching elements 68a, 70a, 72a, 74a, 76a, 78a. The switching elements 68a, 70a, 72a, 74a, 76a, 78a are SPDT relays and of identical structure. Each of the switching elements 68a, 70a, 72a, 74a, 76a, 78a has a first, second and third contact and a coil, it being possible for the first contact to be connected in a conducting manner optionally to the second or third contact by corresponding activation of the coil. The first contact of the switching element 68a is connected in a conducting manner to the emitter of the IGBT 52a. The second contact of the switching element 68a is also connected to the first contact of the switching element 70a. The third contact of the switching element 68a is connected in a conducting manner to the first contact of the switching element 72a. The second contact of the switching element 70a is connected in a conducting manner to the heating connection 10a. The third contact of the switching element 70a is connected in a conducting manner to the heating connection 12a. The second contact of the switching element 72a is connected in a conducting manner to the heating connection 14a. The third contact of the switching element 72a is connected in a conducting manner to the heating connection 16a. The first contact of the switching element 74a is also connected in a conducting manner to the emitter of the IGBT 56a. The second contact of the switching element 74a is also connected to the first contact of the switching element 76a. The third contact of the switching element 74a is connected in a conducting manner to the first contact of the switching element 78a. The second contact of the switching element 76a is connected in a conducting manner to the heating connection 10a. The third contact of the switching element 76a is connected in a conducting manner to the heating connection 12a. The second contact of the switching element 78a is connected in a conducting manner to the heating connection 14a. The third contact of the switching element 78a is connected in a conducting manner to the heating connection 16a.

The heating element 18a is connected with a first contact to the heating connection 10a. The heating element 20a is connected with a first contact to the heating connection 12a. The heating element 22a is connected with a first contact to the heating connection 14a. The heating element 24a is connected with a first contact to the heating connection 16a. A second contact of the heating element 18a is connected in a conducting manner to a second contact of the heating element 20a. A second contact of the heating element 22a is also connected in a conducting manner to a second contact of the heating element 24a. The heating apparatus also has resonant capacitors 80a, 82a, 84a, 86a. The second contact of the heating element 18a is connected in a conducting manner to a first contact of the resonant capacitor 80a and to a first contact of the resonant capacitor 82a. The second contact of the heating element 22a is connected in a conducting manner to a first contact of the resonant capacitor 84a and to a first contact of the resonant capacitor 86a. Second contacts of the two resonant capacitors 80a, 84a are connected in a conducting manner to the collector of the IGBT 52a. Second contacts of the two resonant capacitors 82a, 86a are also connected in a conducting manner to the emitter of the IGBT 58a.

The heating apparatus comprises a control unit 32a, which is provided to control the switching arrangement 66a and the frequency units 26a, 28a by means of activation signals for the inverters 44a, 46a and to set a predefined heating power. The control unit 32a is designed to perform a time multiplex method, with which different operating modes can be used in the individual defined time segments of the time multiplex method. The operating modes used comprise a “dedicated mode”, a “booster mode” and a “phase activation mode”. The control mechanisms can be executed one after the other in different time segments of the time multiplex method.

In “dedicated mode” a frequency unit 26a, 28a supplies just one of the heating elements 18a, 20a, 22a, 24a with energy. The commonly used resonant capacitors 80a, 82a of the heating elements 18a, 20a and the commonly used resonant capacitors 84a, 86a of the heating elements 22a, 24a mean that there are restrictions when assigning the heating elements 18a, 20a, 22a, 24a to the frequency units 26a, 28a. Simultaneous operation of a number of heating elements 18a, 20a, 22a, 24a in dedicated mode is therefore only possible for the heating elements 18a, 20a, 22a, 24a which are connected to different resonant capacitors 80a, 82a, 84a, 86a. The activation signals for the inverters 44a, 46a of the frequency units 26a, 28a are independent of one another in this operating mode.

In booster mode one heating element 18a, 20a, 22a, 24a is operated in each instance by both frequency units 26a, 28a in a parallel manner, to achieve a higher heating power. The activation signals for the inverters 44a, 46a of the frequency units 26a, 28a are identical for both inverters 44a, 46a in this operating mode.

In phase activation mode two heating elements 18a, 20a, 22a, 24a with common resonant capacitors 80a, 82a, 84a, 86a are supplied respectively with energy by one frequency unit 26a, 28a. The activation signals for the inverters 44a, 46a of the frequency units 26a, 28a have the same frequency in this operating mode, thereby setting the total power of the two heating elements 18a, 20a, 22a, 24a. The relationship between the individual heating outputs of the two heating elements 18a, 20a, 22a, 24a is defined by a phase displacement between the activation signals. The activation signals are also adjusted to ensure zero voltage switching of the IGBTs 52a, 54a, 56a, 58a of the inverters 44a, 46a of the frequency units 26a, 28a. This minimizes switching losses.

The frequent switching operations of the switching elements 68a, 70a, 72a, 74a, 76a, 78a of the switching arrangement 66a with the time multiplex method mean that it is important to determine any malfunctions of the switching arrangement 66a or the activation of the switching arrangement 66a. Several hundred thousand switching operations per switching element 68a, 70a, 72a, 74a, 76a, 78a can be expected during the life of the induction cooktop. To minimize malfunctions, the frequency units 26a, 28a are switched off during the switching operations, so that the switching elements 68a, 70a, 72a, 74a, 76a, 78a are without power during the switching operation. But malfunction still cannot be totally excluded. Possible malfunctions include on the one hand malfunctions of the switching elements 68a, 70a, 72a, 74a, 76a, 78a, for example a catching relay or a defective component in a control power circuit of the relay, or on the other hand malfunctions of the control software of the switching elements 68a, 70a, 72a, 74a, 76a, 78a.

With the inventive heating apparatus a method is used, in which the existence of a conducting path between a frequency unit 26a, 28a and a heating connection 10a, 12a, 14a, 16a is determined by a protective unit 30a of the heating apparatus. The protective unit 30a determines the existence of the conducting path between one of the two frequency units 26a, 28a and one of the four heating connections 10a, 12a, 14a, 16a in at least one operating state based on a potential profile, which it analyzes at the heating connections 10a, 12a, 14a, 16a.

FIG. 2 shows a Cartesian coordinate system for a typical potential profile V₁(t) at a heating connection 10a, 12a, 14a, 16a when a conducting path exists between the heating connection 10a, 12a, 14a, 16a and a frequency unit 26a, 28a. The ordinate axis 88a shows the electrical potential V₁ at the heating connection 10a, 12a, 14a, 16a. The abscissa axis 90a shows a time t. The potential profile V₁(t) essentially has the form of a square-wave signal with steep flanks. Sharp edges mean that a frequency spectrum of the potential profile V₁(t) contains high-frequency signal components, the frequency of which is above a switching frequency of the frequency units 26a, 28a.

FIG. 3 shows a Cartesian coordinate system for a typical potential profile V₂(t) at a heating connection 10a, 12a, 14a, 16a in the absence of a conducting path between the heating connection 10a, 12a, 14a, 16a and a frequency unit 26a, 28a. The ordinate axis 92a shows the electrical potential V₂ at the heating connection 10a, 12a, 14a, 16a. The abscissa axis 94a shows a time t. The potential profile V₂(t) essentially has the form of a sinusoidal signal displaced in the direction of the ordinate axis 92a by U₀/2. The potential profile V₂(t) at the heating connection 10a, 12a, 14a, 16a is identical to a potential profile on a side of the heating element 18a, 20a, 22a, 24a assigned to the heating connection 10a, 12a, 14a, 16a facing away from said heating connection 10a, 12a, 14a, 16a, as in the absence of a conducting path between the heating connection 10a, 12a, 14a, 16a and the frequency unit 26a, 28a a current flow through the heating element 18a, 20a, 22a, 24a is zero. The approximately sinusoidal profile means that only a few signal components are contained in a frequency spectrum of the potential profile V₂(t), their frequencies being around the switching frequency of the frequency units 26a, 28a.

To distinguish between the two different potential profiles V₁(t), V₂(t), the protective unit 30a comprises a high-pass filter with a limit frequency above the switching frequency of the frequency units 26a, 28a for each heating connection 10a, 12a, 14a, 16a. Signal components of the potential profiles V₁(t), V₂(t) with frequencies below the limit frequency are significantly damped, while signals with frequencies above the limit frequency are left almost unchanged. This allows discrimination between the potential profiles V₁(t), V₂(t) in respect of their frequency spectrum and the protective unit 30a can determine whether the conducting path exists between the heating connection 10a, 12a, 14a, 16a and a frequency unit 26a, 28a. If the conducting path exists, the protective unit 30a outputs a logic “0”. If the conducting path is absent, the protective unit 30a outputs a logic

Let it be assumed in one example that the two heating elements 18a, 24a are to be operated in dedicated mode. When the switching arrangement 66a is in the correct switch position, the two switching elements 68a, 70a are in the upper position and the switching elements 74a, 78a are in the lower position. The protective unit 30a forwards corresponding connection information to the control unit 32a, which the control unit 32a compares with a setpoint switch position. In the present instance the protective unit 30a forwards a “0” for the heating connection 10a, a “1” for the heating connection 12a, a “1” for the heating connection 14a and a “0” for the heating connection 16a. If we assume that the switching element 70a is in the wrong position, being in the lower position instead of the upper position, the protective unit 30a forwards a “1” for the heating connection 10a, a “0” for the heating connection 12a, a “1” for the heating connection 14a and a “0” for the heating connection 16a to the control unit 32a. In this error mode the heating element 20a is erroneously supplied with energy, which can potentially result in a dangerous operating state for an operator. The control unit 32a identifies this wrong position and switches off all the frequency units 26a, 28a. The control unit 32a also outputs a warning message and a maintenance request to an operator. If we assume that the switching element 68a is in the wrong position, being in the lower position instead of the upper position, the protective unit 30a forwards a “1” for the heating connection 10a, a “1” for the heating connection 12a, either a “0” or a “1” for the heating connection 14a as a function of a switch position of the switching element 72a and a “0” for the heating connection 16a to the control unit 32a. If the switching element 72a is in the upper position, the heating element 22a is erroneously supplied with energy, which can potentially result in a dangerous operating state for an operator. If the switching element 72a is in the lower position, both frequency units 26a, 28a are connected to the heating element 24a in a parallel manner and if the activation signals are different, in particular if the phasings are different, a short circuit of the inverters 44a, 46a and their destruction can result for the inverters 44a, 46a of the frequency units 26a, 28a. The control unit 32 identifies this wrong position and switches off all the frequency units 26a, 28a. The control unit 32a also outputs a warning message and a maintenance request to an operator.

Let it be assumed in a further example that the heating element 18a is to be operated in booster mode. When the switching arrangement 66a is in the correct switch position, the four switching elements 68a, 70a, 74a, 78a are in the upper position. The protective unit 30a forwards corresponding connection information to the control unit 32a, which the control unit 32a compares with a setpoint switch position. In the present instance the protective unit 30a forwards a “0” for the heating connection 10a, a “1” for the heating connection 12a, a “1” for the heating connection 14a and a “1” for the heating connection 16a. If we assume that the switching element 76a is in the wrong position, being in the lower position instead of the upper position, the protective unit 30a outputs a “0” for the heating connection 10a, a “0” for the heating connection 12a, a “1” for the heating connection 14a and a “1” for the heating connection 16a to the control unit 32a. In this error mode the two heating elements 18a, 20a are operated in a phase activation mode with activation signals of the inverters 44a, 46a of the frequency units 26a, 28a that have not been adapted for voltage-free switching. This can result in more significant switching losses and increased heating of the inverters 44a, 46a. The heating element 20a is also erroneously supplied with energy, which can potentially result in a dangerous operating state for an operator. The control unit 32a identifies this wrong position and switches off all the frequency units 26a, 28a. The control unit 32a also outputs a warning message and a maintenance request to an operator. If we assume that the switching element 74a is in the wrong position, being in the lower position instead of the upper position, the protective unit 30a forwards a “0” for the heating connection 10a, a “1” for the heating connection 12a and either a “0” for the heating connection 14a and a “1” for the heating connection 16a or a “1” for the heating connection 14a and a “0” for the heating connection 16a as a function of a switch position of the switching element 78a to the control unit 32a. In this error mode either the heating element 22a or the heating element 24a is erroneously supplied with energy as a function of the switching state of the switching element 78a, which can potentially result in a dangerous operating state for an operator. The control unit 32a identifies this wrong position and switches off all the frequency units 26a, 28a. The control unit 32a also outputs a warning message and a maintenance request to an operator.

Let it be assumed in a last example that the two heating elements 18a, 20a are to be operated in phase activation mode. When the switching arrangement 66a is in the correct switch position, the three switching elements 68a, 70a, 74a are in the upper position and the switching element 76a is in the lower position. The protective unit 30a forwards corresponding connection information to the control unit 32a, which the control unit 32a compares with a setpoint switch position. In the present instance the protective unit 30a forwards a “0” for the heating connection 10a, a “0” for the heating connection 12a, a “1” for the heating connection 14a and a “1” for the heating connection 16a. If we assume that the switching element 76a is in the wrong position, being in the upper position instead of the lower position, the protective unit 30a forwards a “0” for the heating connection 10a, a “1” for the heating connection 12a, a “1” for the heating connection 14a and a “1” for the heating connection 16a to the control unit 32a. In this error mode the two frequency units 26a, 28a are connected to the heating element 18a in a parallel manner and if the activation signals are different, in particular if the phasings are different, a short circuit of the inverters 44a, 46a and their destruction can result for the inverters 44a, 46a of the frequency units 26a, 28a. The control unit 32 identifies this wrong position and switches off all the frequency units 26a, 28a. The control unit 32a also outputs a warning message and a maintenance request to an operator. If we assume that the switching element 74a is in the wrong position, being in the lower position instead of the upper position, the protective unit 30a forwards a “0” for the heating connection 10a, a “1” for the heating connection 12a and either a “0” for the heating connection 14a and a “1” for the heating connection 16a or a “1” for the heating connection 14a and a “0” for the heating connection 16a as a function of a switch position of the switching element 78a to the control unit 32a. In this error mode either the heating element 22a or the heating element 24a is erroneously supplied with energy as a function of a switch position of the switching element 78a, which can potentially result in a dangerous operating state for an operator. The control unit 32a identifies this wrong position and switches off all the frequency units 26a, 28a. The control unit 32a also outputs a warning message and a maintenance request to an operator.

Alternatively or additionally the protective unit 30a can also comprise a current sensor, in order to determine the existence of the conducting path in at least one operating state. Alternatively or additionally the heating apparatus can comprise at least one current meter, which is provided to measure an electrical current through the conducting path.

FIGS. 4a and 4b show a further exemplary embodiment of the invention. The descriptions which follow are limited essentially to the differences between the exemplary embodiments, it being possible to refer to the description of the other exemplary embodiments, in particular FIGS. 1a and 1b, in respect of identical components, features and functions. To distinguish between the exemplary embodiments the letter a in the reference characters of the exemplary embodiment in FIGS. 1a and 1b is replaced by the letter b in the reference characters of the exemplary embodiment in FIGS. 4a and 4b. Reference can also be made in principle to the drawings and/or the description of the other exemplary embodiment, in particular in FIGS. 1a and 1b, in respect of identically designated components, in particular in respect of components with identical reference characters.

FIG. 4a shows a second induction cooktop with a cooktop plate 34b made of a glass ceramic, viewed from above. Three circular heating zones 36b, 38b, 40b are marked on the cooktop plate 34b in the known manner. FIG. 4b shows an electrical circuit diagram of a second heating apparatus of the second induction cooktop. The heating apparatus only comprises three heating elements 18b, 20b, 22b, which can be connected by way of a switching arrangement 66b to two frequency units 26b, 28b. To minimize production costs by reducing the number of different types of heating apparatuses, the heating apparatus from FIG. 4b also comprises a heating connection 16b for a fourth heating element, which can be connected by way of the switching element 72b to the frequency unit 26b and by way of the switching element 78b to the frequency unit 28b. This gives rise to a further possible error, namely where one of the two switching elements 72b, 78b establishes a conducting path between one of the frequency units 26b, 28b and the heating connection 16b. An inverter 44b, 46b of the frequency unit 26b, 28b would then have a damping capacitor unit 48b, 50b associated with the frequency unit 26b, 28b as its only load. The inverters 44b, 46b can survive this operating mode undamaged for a short time. The purpose of a protective unit 30b of the heating apparatus is to identify this operating mode promptly. See the description of the previous exemplary embodiment for a precise description of the mode of operation of the protective unit 30b.

In principle it is conceivable for a heating apparatus to have further switching elements and more than four heating elements, which are connected to frequency units by means of the further switching elements. In principle it is conceivable for the switching elements, which are configured as SPDT relays, each to be replaced by two SPST relays.

### REFERENCE CHARACTERS

| | |
|---|---|
| 10a | Heating connection |
| 10b | Heating connection |
| 12a | Heating connection |
| 12b | Heating connection |
| 14a | Heating connection |
| 14b | Heating connection |
| 16a | Heating connection |
| 16b | Heating connection |
| 18a | Heating element |
| 18b | Heating element |
| 20a | Heating element |
| 20b | Heating element |
| 22a | Heating element |
| 22b | Heating element |
| 24a | Heating element |
| 26a | Frequency unit |
| 26b | Frequency unit |
| 28a | Frequency unit |
| 28b | Frequency unit |
| 30a | Protective unit |
| 30b | Protective unit |
| 32a | Control unit |
| 32b | Control unit |
| 34a | Cooktop plate |
| 34b | Cooktop plate |
| 36a | Heating zone |
| 36b | Heating zone |
| 38a | Heating zone |
| 38b | Heating zone |
| 40a | Heating zone |
| 40b | Heating zone |
| 42a | Heating zone |
| 44a | Inverter |
| 44b | Inverter |
| 46a | Inverter |
| 46b | Inverter |
| 48a | Damping capacitor unit |
| 48b | Damping capacitor unit |
| 50a | Damping capacitor unit |
| 50b | Damping capacitor unit |
| 52a | IGBT |
| 52b | IGBT |
| 54a | IGBT |
| 54b | IGBT |
| 56a | IGBT |
| 56b | IGBT |
| 58a | IGBT |
| 58b | IGBT |
| 60a | Alternating current voltage source |
| 60b | Alternating current voltage source |
| 62a | Filter |
| 62b | Filter |
| 64a | Rectifier |
| 64b | Rectifier |
| 66a | Switching arrangement |
| 66b | Switching arrangement |
| 68a | Switching element |
| 68b | Switching element |
| 70a | Switching element |
| 70b | Switching element |
| 72a | Switching element |
| 72b | Switching element |
| 74a | Switching element |
| 74b | Switching element |
| 76a | Switching element |
| 76b | Switching element |
| 78a | Switching element |
| 78b | Switching element |
| 80a | Resonant capacitor |
| 80b | Resonant capacitor |
| 82a | Resonant capacitor |
| 82b | Resonant capacitor |
| 84a | Resonant capacitor |
| 84b | Resonant capacitor |
| 86a | Resonant capacitor |
| 86b | Resonant capacitor |
| 88a | Ordinate axis |
| 90a | Abscissa axis |
| 92a | Ordinate axis |
| 94a | Abscissa axis |
| U₀ | Rectified voltage |
| V₁(t) | Potential profile |
| V₂(t) | Potential profile |
| V₁ | Potential |
| V₂ | Potential |
| t | Time |

1-10. (canceled)

11. A heating apparatus comprising:
at least one heating connection for at least one heating element,
at least one frequency unit, and
a protective unit configured to determine whether a conducting path exists between the frequency unit and the at least one heating connection.

12. The heating apparatus of claim 11, wherein the heating apparatus is constructed as a cooktop heating apparatus.

13. The heating apparatus of claim 11, wherein the protective unit is configured to determine whether the conducting path exists based on a potential profile.

14. The heating apparatus of claim 13, wherein the protective unit is configured to analyze the potential profile at the at least one heating connection.

15. The heating apparatus of claim 13, wherein the protective unit is configured to determine whether the conducting path exists based on a frequency spectrum of the potential profile.

16. The heating apparatus of claim 13, wherein the protective unit comprises at least one high-pass filter configured to discriminate between potential profiles.

17. The heating apparatus of claim 11, wherein the protective unit comprises a current sensor configured to determine whether the conducting path exists.

18. The heating apparatus of claim 11, further comprising a control unit configured to receive connection information from the protective unit and to initiate at least one safety measure when a faulty conducting path exists.

19. The heating apparatus of claim 11, wherein a total number of heating elements is greater than a total number of frequency units.

20. A method for determining whether a conducting path exists between a frequency unit and at least one heating connection for at least one heating element in a heating apparatus, comprising:
evaluating a potential profile at the at least one heating connection;
determining whether a current flow through a heating element associated with the at least one heating connection produces a potential profile having frequencies in a range around switching frequencies of the frequency unit;
determining a switch position of switching elements for the at least one heating connection is in agreement with the potential profile;
disconnecting the frequency unit from the at least one heating connection when a faulty conducting path is detected based on disagreement between the switch position and the potential profile, and
outputting a warning message and a service request to a user.

21. The method of claim 20, wherein the heating apparatus is a cooktop apparatus.

22. A cooktop, comprising a heating apparatus with at least one heating connection for at least one heating element, at least one frequency unit, and a protective unit configured to determine whether a conducting path exists between the frequency unit and the at least one heating connection.

23. The cooktop of claim 22, wherein the cooktop is an induction cooktop.

24. The cooktop of claim 22, wherein the heating apparatus is constructed as a cooktop heating apparatus.

25. The cooktop of claim 22, wherein the protective unit is configured to determine whether the conducting path exists based on a potential profile.

26. The cooktop of claim 25, wherein the protective unit is configured to analyze the potential profile at the at least one heating connection.

27. The cooktop of claim 25, wherein the protective unit is configured to determine whether the conducting path exists based on a frequency spectrum of the potential profile.

28. The cooktop of claim 25, wherein the protective unit comprises at least one high-pass filter configured to discriminate between potential profiles.

29. The cooktop of claim 22, wherein the protective unit comprises a current sensor configured to determine whether the conducting path exists.

30. The cooktop of claim 22, wherein the heating apparatus includes a control unit configured to receive connection information from the protective unit and to initiate at least one safety measure when a faulty conducting path exists.

31. The cooktop of claim 22, wherein a total number of heating elements is greater than a total number of frequency units.
